(19) United States
(12) Patent Application Publication
(10) Pub. No.: US 2004/0117734 A1
(43) Pub. Date: Jun. 17, 2004

(54) Method and apparatus for structuring texts

(76) Inventor: Frank Krickhahn, Herzogenaurach (DE)

Correspondence Address: HARNESS, DICKEY & PIERCE, P.L.C., P.O.BOX 8910, RESTON, VA, 20195, US

(21) Appl. No.: 10/673,230

(22) Filed: Sep. 30, 2003

(30) Foreign Application Priority Data
Sep. 30, 2002 (DE) 10245876.6

(51) Int. Cl. G06F 17/00

(52) U.S. Cl. 715/513

(57) ABSTRACT

A method and apparaptus are for the rule-based conversion of unstructured text information into a structured format. The method includes inputting structuring rules for structuring the unstructured text information and recording unstructured text information. The the unstructured text information is then parsed in order to produce small text fragments. Text units of the unstructured text information are then searched for text fragments defined in the structuring rules. The text fragments of the unstructured text information are structured on the basis of conditions stipulated in the structuring rules.

The present application hereby claims priority under 35 U.S.C. §119 on German patent application number DE 102 45 876.6 filed Sep. 30, 2002, the entire contents of which are hereby incorporated herein by reference.

### FIELD OF THE INVENTION

The invention generally relates to a method and apparatus for converting unstructured text information into a structured format.

### BACKGROUND OF THE INVENTION

Particularly in medical engineering, many free text reports are produced today which are recorded in the computer using dictaphones and/or voice recognition technologies, for example. The problem when handling these reports is that automatic access to small information parts, “atomic information”, is almost impossible because the content contains no or just a very coarse structure. Free text reports are therefore very unsuitable for structured presentation and evaluation of the information.

In such free text reports, only integrated information is processed. This information cannot be used for automatic evaluations. Thus, the information it contains is thus lost for this purpose. This problem is growing as the need for access to the atomic information, for example for the purpose of coding, increases.

Aho, Alfred V. et al, “Compilers—Principles, Techniques and Tools”, Addison Wesley, Reading, Mass., 1986, pages 4 to 11, the entire contents of which are incorporated herein by reference, describes the principle of parsing.

Wormek A. K. et al., “SAM: Speech-Aware Applications in Medicine to Support Structured Data Entry”, the entire contents of which are incorporated herein by reference, discloses a method for the structured input of data by voice.

In these documents, unstructured text information is converted into a structure on the basis of the derivation of one structure from another. These resultant structures also cannot be used for automatic evaluations.

### SUMMARY OF THE INVENTION

An embodiment of the invention is based on an object of providing a method and an apparatus which allow simple, automated conversion of unstructured text information from free text reports into a structured, evaluatable format.

An embodiment of the invention achieves an object via a method having the following steps:

a) structuring rules for structuring the unstructured text information are input,

b) unstructured text information is recorded,

c) the unstructured text information is parsed in order to produce small text fragments,

d) text units of the unstructured text information are searched for text fragments defined in the structuring rules,

e) the text fragments of the unstructured text information are structured on the basis of conditions stipulated in the structuring rules.

The structuring rules to be defined parse the free text report, i.e. break it down into smaller units, and convert it into a structure which allows a program to evaluate this information. Such a rule contains information relating to the text fragments for which the free text report needs to be searched, which structure element is represented thereby, and additional information about how the structure needs to be set up.

In line with the invention, unstructured text information can be recorded in step b) by a microphone, with a voice recognition program being used for conversion into unstructured text information.

Advantageously, the structuring rules can contain information relating to the text fragments for which the free text report needs to be searched, about which structure element is represented thereby and about how the structure needs to be set up.

An embodiment of the invention achieves an object for the apparatus by way of an input apparatus for unstructured text information, an input apparatus and a memory apparatus for structuring rules, an extraction apparatus for small text units from the unstructured text information, a structuring apparatus for producing structured text information on the basic of the structuring rules, and an evaluation apparatus for the text units in the structured text information.

Evaluatable unstructured text information can be input directly if the input apparatus for unstructured text information has an associated apparatus for voice recognition.

It has been found to be advantageous if DICOM-SR or XML is used as structured format for the structured text information.

### BRIEF DESCRIPTION OF THE DRAWINGS

The present invention will become more fully understood from the detailed description of preferred embodiments given hereinbelow and the accompanying drawings, which are given by way of illustration only and thus are not limitative of the present invention, and wherein:

FIG. 1 shows an apparatus in accordance with an embodiment of the invention for structuring texts, and

FIG. 2 shows a method in accordance with an embodiment of the invention for structuring texts.

### DETAILED DESCRIPTION OF THE PREFERRED EMBODIMENTS

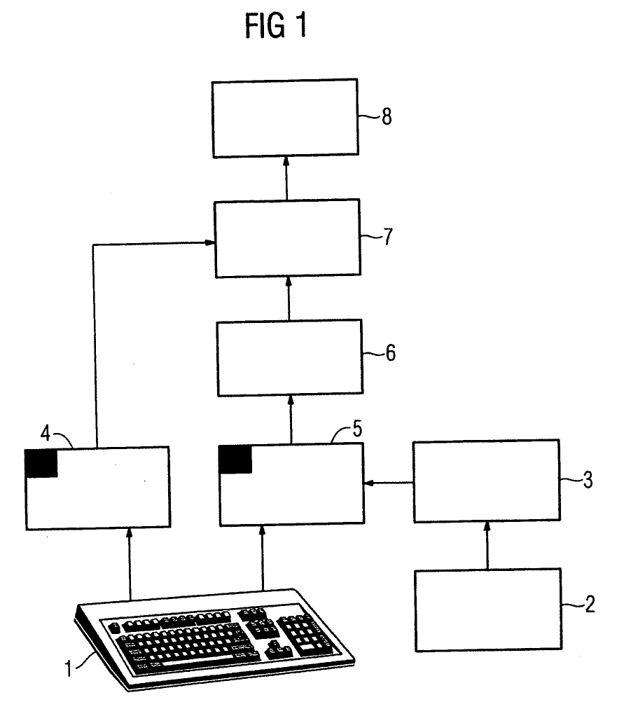

FIG. 1 shows an apparatus in accordance with an embodiment of the invention for structuring texts. The apparatus can be implemented in a personal computer (PC), for example. A keyboard 1, for example, may be used for inputting structuring rules and possibly free text reports. In addition, the apparatus can have a voice input apparatus 2, for example a microphone or a cassette player, which can be used to input the free text reports into the PC. The voice input apparatus 2 has an apparatus 3 for voice recognition, for example with a voice recognition program, connected to it which can be used to convert the spoken free text reports into text information.

The keyboard 1 is connected to a memory apparatus 4 for structuring rules and to a memory apparatus 5 for text information, to which the apparatus 3 for voice recognition is also connected. The memory apparatus 5 for text information has an extraction apparatus 6 connected to it which recognizes and identifies small text units from the unstructured text information. The extraction apparatus 6 and the memory apparatus 4 for the structuring rules have a structuring apparatus 7 for producing structured text information connected to them which converts the extracted text units into a structured format on the basis of the stipulated and stored structuring rules. The structuring apparatus 7 has an evaluation apparatus 8 connected to it which allows a check for small, structured text units for further evaluation.

In a medical facility, free text reports are recorded, for example using a dictaphone, and are later transferred to the computer by a secretary using a writing program via the keyboard 1. A free text report can also be converted into a written text by the apparatus 3 for voice recognition, using an appropriate voice recognition program, the free text report being able to be input directly into a personal computer by means of dictation or subsequently using a player for dictation cassettes.

To allow later evaluations of the stocks of data produced in this manner, the free text reports are converted into a structured format, for example DICOM-SR or XML, in addition to their original format. For this purpose, rules are defined which stipulate the systematics of conversion.

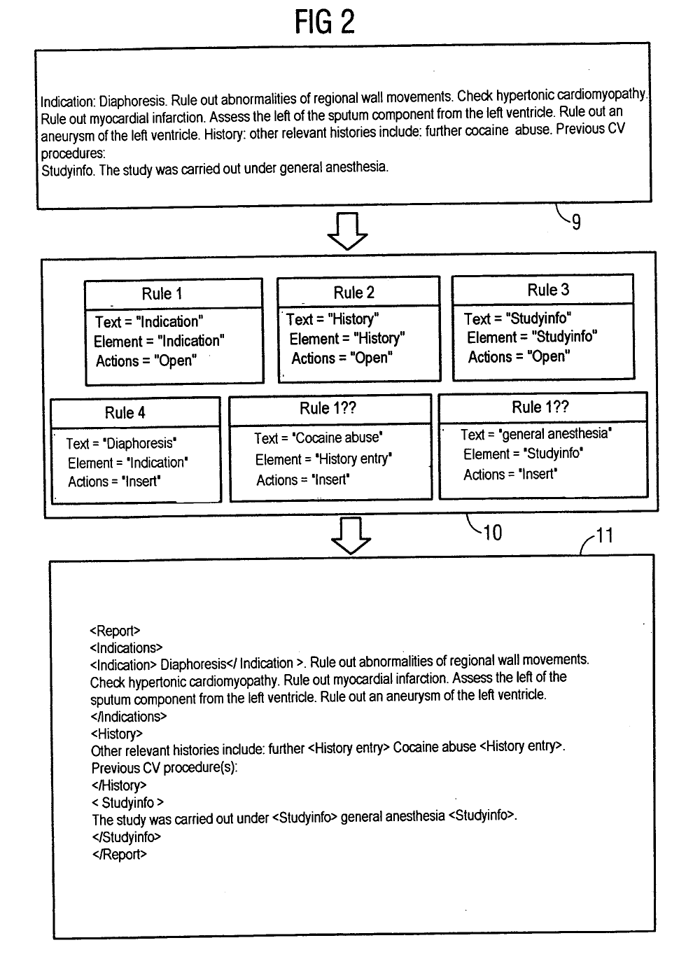

The starting point is unstructured text information 9, shown in FIG. 2, which has been produced by way of dictation or free text input. This text information 9 is used as input for an apparatus which is intended to convert this unstructured text information 9 into a structured form.

FIG. 2 gives the following as an example of unstructured text information 9:

Indication: Diaphoresis. Rule out abnormalities of regional wall movements. Check hypertonic cardiomyopathy. Rule out myocardial infarction. Assess the left of the sputum component from the left ventricle. Rule out an aneurysm of the left ventricle. History: other relevant histories include: further cocaine abuse. Previous CV procedures:

Studyinfo. The study was carried out under general anesthesia.

To convert this unstructured text information 9 into a structured form, structuring rules 10 are input into this apparatus using the keyboard 1 and are stored in the memory apparatus 4, these structuring rules forming the basis of the conversion.

These structuring rules 10 define those text fragments for which the text needs to be searched and what result the finding of such a text fragment has in the conversion. In the example described below, finding the text fragment “Indication”, for example, signifies that a new element which describes an indication is inserted into the structure.

The text below gives examples of such structuring rules 10, which are shown in FIG. 2. The general basis is that structuring rules 10 are defined which stipulate, on the basis of the finding of text fragments, how unstructured text information 9 is transferred to a structured form.

If the text contains the word “Indication”, then the word needs to be handled with open actions under element “Indication”. The same applies for the word “History” as “History” element and for “Studyinfo” as “Studyinfo” element.

If the text contains the word “Diaphoresis”, then it needs to be inserted as an action under element “Indication”. The word “Cocaine abuse” in the text needs to be inserted under element “History entry”. The term “General anesthesia” needs to be inserted under element “Studyinfo”.

These and other structuring rules 10 which have been input once, but can be changed at any time, are used to put unstructured text information 9 from the free text report into a structured form, so that the structured text information 11 which has now been obtained and which is described below can be searched for particular terms.

<Report>

<Indications>

<Indication> Diaphoresis</ Indication >. Rule out abnormalities of regional wall movements. Check hypertonic cardiomyopathy. Rule out myocardial infarction. Assess the left of the sputum component from the left ventricle. Rule out an aneurysm of the left ventricle.

</Indications>

<History>

Other relevant histories include: further <History entry> Cocaine abuse <History entry>. Previous CV procedure(s):

</History>

< Studyinfo >

The study was carried out under <Studyinfo> general anesthesia <Studyinfo>.

</Studyinfo>

</Report>

In this case, the invention involves unstructured text information being converted into a structure on the basis of the rule-based interpretation of contents.

Thus, by way of example, two documents can contain the following text passages:

a) “The patient was subjected to an extensive examination. An intestinal tumor was diagnosed.”

b) “Following a CT-based examination, a tumor in the intestinal tract was diagnosed”.

To structure the diagnosis, the following rules can be applied:

1. If a sentence contains the words “diagnosed”, “diagnostic result” or “diagnosis”, then it contains information relating to diagnosis.

1.1. If the same sentence contains the word “tumor” or “malignant tumor”, a tumor has been discovered.

1.1.1. If the same sentence contains the word “intestine” or “intestinal tract”, then intestinal cancer has been diagnosed.

1.2. If the sentence contains the word “intestinal tumor” or “intestinal cancer”, then intestinal cancer has been diagnosed.

The same text fragment is analyzed in this manner from a wide variety of aspects. The knowledge obtained from these analyses is then converted into corresponding structures:

<Diagnosis>

<Code> DF-0044A </CODE>

<Meaning> Intestinal cancer </Meaning>

</Diagnosis>

It is thus possible to access atomic information automatically, since the content is given a finely structured form by the inventive apparatus. Hence, free text reports can also be used for structured presentation and automatic evaluation of the information.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed:

1. A method for rule-based conversion of unstructured text information into a structured format, comprising:
inputting structuring rules for structuring the unstructured text information;
recording unstructured text information;
parsing the unstructured text information to produce relatively smaller text fragments;
searching the unstructured text information for text fragments defined in the structuring rules; and
structuring the text fragments of the unstructured text information on the basis of conditions stipulated in the structuring rules.

2. The method as claimed in claim 1, wherein the unstructured text information is recorded by a microphone, and wherein a voice recognition program is used for conversion to the unstructured text information.

3. The method as claimed in claim 1, wherein the structuring rules include information relating to the text fragments for which a free text report needs to be searched.

4. The method as claimed in claim 1, wherein the structuring rules include information relating to the text fragments about which structure element is represented thereby.

5. The method as claimed in claim 1, wherein the structuring rules include information about how the structure needs to be set up.

6. An apparatus for rule-based conversion of unstructured text information into a structured format, comprising:
an input apparatus, adapted to input unstructured text information;
an apparatus, adapted to structure rules;
an extraction apparatus, adapted to extract relatively smaller text units from the unstructured text information;
a structuring apparatus, adapted to produce structured text information on the basis of the structuring rules; and
an evaluation apparatus, adapted to evaluate the text units in the structured text information.

7. The apparatus as claimed in claim 6, wherein the input apparatus includes an associated apparatus for voice recognition.

8. The apparatus as claimed in claim 6, wherein DICOM-SR is used as structured format for the structured text information.

9. The apparatus as claimed in claim 6, wherein XML is used as structured format for the structured text information.

10. The method as claimed in claim 2, wherein the structuring rules include information relating to the text fragments for which a free text report needs to be searched.

11. The method as claimed in claim 2, wherein the structuring rules include information relating to the text fragments about which structure element is represented thereby.

12. The method as claimed in claim 2, wherein the structuring rules include information about how the structure needs to be set up.

13. The apparatus as claimed in claim 7, wherein DICOM-SR is used as structured format for the structured text information.

14. The apparatus as claimed in claim 7, wherein XML is used as structured format for the structured text information.

15. The apparatus as claimed in claim 8, wherein XML is used as structured format for the structured text information.

16. An apparatus for rule-based conversion of unstructured text information into a structured format, comprising:
means for inputting structuring rules for structuring the unstructured text information;
means for recording unstructured text information;
means for parsing the unstructured text information to produce relatively smaller text fragments;
means for searching the unstructured text information for text fragments defined in the structuring rules; and
means for structuring the text fragments of the unstructured text information on the basis of conditions stipulated in the structuring rules.

17. The apparatus as claimed in claim 16, wherein the means for recording includes a microphone, and wherein the means for inputting includes a voice recognition program for conversion to the unstructured text information.

18. The method as claimed in claim 16, wherein the structuring rules include information relating to the text fragments for which a free text report needs to be searched.

19. The method as claimed in claim 16, wherein the structuring rules include information relating to the text fragments about which structure element is represented thereby.

20. The method as claimed in claim 16, wherein the structuring rules include information about how the structure needs to be set up.
